(19) United States
(12) Patent Application Publication
(10) Pub. No.: US 2020/0324304 A1
(43) Pub. Date: Oct. 15, 2020

(54) DEVICE FOR SPRAYING ADHESIVE AND METHOD

(71) Applicant: Illinois Tool Works Inc., Glenview, IL (US)

(72) Inventor: Andreas Pahl, Erkrath (DE)

(21) Appl. No.: 16/640,840

(22) PCT Filed: Aug. 28, 2018
(86) PCT No.: PCT/IB18/01108

§ 371 Date: Feb. 21, 2020

(30) Foreign Application Priority Data
Sep. 1, 2017 (DE) 1020170082278

(51) Int. Cl. B05B 1/16; B05B 1/04; B05D 1/02; B05D 5/10

(52) U.S. Cl. CPC B05B 1/169; B05D 5/10; B05D 1/02; B05B 1/044

(57) ABSTRACT

A device for spraying adhesive onto a substrate or workpiece, for example, an automotive workpiece, includes at least one spray nozzle for discharging the adhesive having at least two adhesive inlets and at least two regions of adhesive outlets. One of the regions of adhesive outlets which can be supplied separately with a width of less than 25 mm is connected to precisely one of the adhesive inlets.

The present patent application relates according to a first aspect to a device for spraying adhesive onto a substrate or workpiece.

For example, in the field of the automotive industry, it is desirable to provide predetermined workpieces, such as, for example, motor vehicle inner space trim components, with adhesive strips so that using these adhesive strips a coating, such as, for example, a decorative material, can be subsequently adhesively bonded to the workpiece or carrier.

The adhesive nozzles which are used in this instance may, for example, be moved using a robot arm in/along the desired application direction or path, wherein they typically apply the adhesive in uniformly wide strips to the substrate or workpiece.

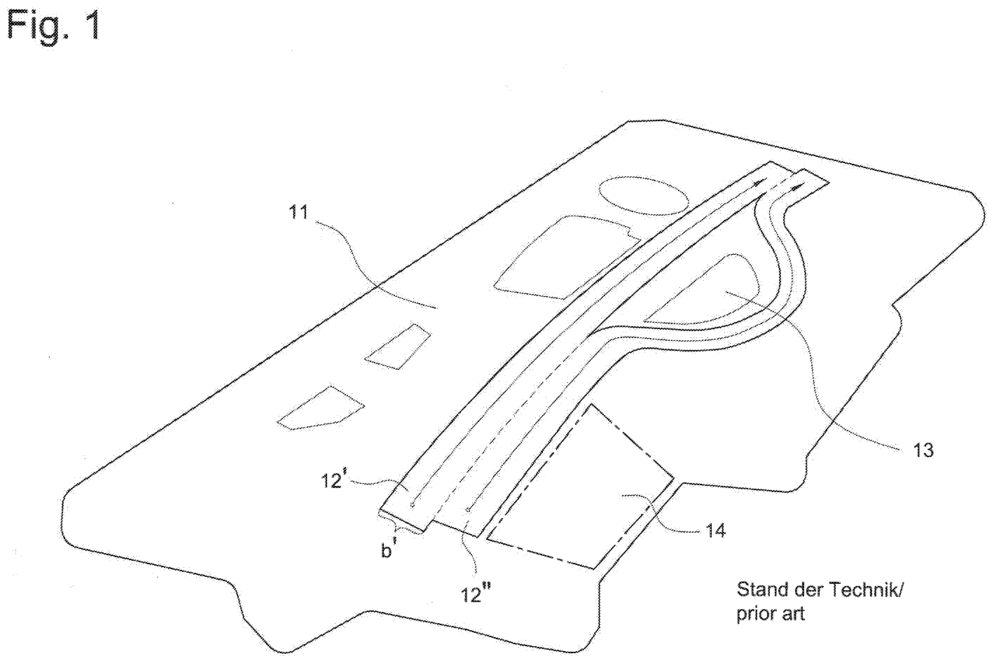

The result of an application method according to the prior art is illustrated, for example, in FIG. 1, according to which a workpiece 11 which is constructed as a door panel is provided with adhesive strips 12′ or 12″ having a width b′.

Whilst the application path 12′ could still be applied in a relatively unproblematic manner along a straight line, a recess 13 in the workpiece 11 would lead to a deviation of the adhesive path 12″ from a straight line, up to a winding, curved application path 12″.

This application method not only ensures an inadequate application of adhesive around the recess 13. Instead, also in other regions, such as, for example, the trapezoidal portion 14 of the workpiece 11 illustrated with broken lines, there is also a problem in that it is not constructed in a substantially rectangular manner or with a uniform width, but instead has an irregular width. When the portion 14 is fully wetted with adhesive, this leads to multiple occurrences of overlapping of the path which are not desirable.

The pattern illustrated in FIG. 1 is achieved by moving twice over the workpiece 11 with a device in which a spray nozzle is used having a region of adhesive outlets which typically has a width of approximately 30 mm so that the corresponding application path also has an application width b′ of approximately 30 mm. This region of adhesive outlets is in this instance typically associated together with an adhesive inlet or a plurality of adhesive inlets of the nozzle.

Based on a device of the prior art, which leads to the result according to FIG. 1, an object of the present invention is accordingly to enable a more comfortable application of the adhesive.

This object is achieved by the invention according to a first aspect with the features of patent claim 1, in particular with those of the characterizing portion, and is accordingly characterized in that one of the regions of adhesive outlets which can be supplied separately with a width of less than 25 mm is connected to precisely one of the adhesive inlets.

The invention accordingly substantially involves the adhesive outlets of a spray nozzle being sub-divided into regions which can be controlled or which respond separately, in particular in such a manner that the spray nozzle—depending on requirements—can also use only a portion of the adhesive outlets thereof in order to achieve an adhesive strip less than 25 mm wide.

In this manner, for example, it is possible to dispense with the above-described curved departure from paths. It is thus possible in a simple manner for the adhesive application for substantially linear, parallel, non-curved paths to be travelled.

The small possible adhesive strip width thereby also enables, for example, recesses such as the recess 13 described above in the workpiece 11 to be approached sufficiently closely without having to bypass the contour thereof (as in the prior art).

The application is carried out in this sense with a higher resolution or smaller adhesive strip width. This enables, for example, simpler programming or control of a robot arm on which the nozzle or nozzles is/are fitted.

It is also possible to substantially avoid overlapping adhesive regions. The width of an adhesive strip may in this instance—even when known nozzle widths are used—be limited to less than 25 mm, for example, less than 20 mm, in particular less than 15 mm, for example 12.5 mm.

As a result of the simplified path guiding, it is also possible in particular to achieve a time saving when the adhesive is applied.

A spray nozzle according to the invention typically has in this instance several regions of adhesive outlets, which are not connected to each other and which are also supplied separately (so as to be able to be switched). In this context, precisely one adhesive inlet of the nozzle may be clearly associated with each region of adhesive outlets. This enables the separate switching of the two adhesive outlet regions, for example, by means of a valve which is in each case connected upstream of the nozzle. In this context, precisely one valve (module) may be connected upstream of each adhesive inlet of the nozzle.

This results in the nozzle, when it is displaced in the movement direction over a workpiece in all regions of adhesive outlets, being able to be first opened or supplied with adhesive so that a relatively wide adhesive strip is achieved. However, if this adhesive strip occasionally meets an opening in the workpiece, the regions of adhesive outlets which are intended to be guided over the opening can then be briefly switched off using the valves which are associated therewith. The remaining regions of adhesive outlets which are located above the workpiece and which are still supplied can then discharge adhesive in a narrow adhesive strip.

Typically, two regions of adhesive outlets which can be switched or respond separately may be associated with a nozzle.

In this instance, the nozzle typically also has two adhesive inlets and two separate adhesive channels which are isolated from each other, that is to say, one from the first adhesive inlet to the first region of adhesive outlets and one from the second adhesive inlet to the second region of adhesive outlets.

The material which is intended to be applied or sprayed is an adhesive, in particular a highly viscous medium. Typically, there are sprayed so-called hot melts or hot melt adhesives which are heated beforehand in the device or a heating device associated with the device. These hot melt adhesives are considered to be particularly reliable.

The adhesive is applied in a spraying manner using the device according to the invention. To this end, in the region of the adhesive outlets, spraying agents are generally added, such as, for example, spraying air, to the adhesive, in order to carry it in a selective manner from the device to the substrate or workpiece. The nozzles therefore typically also have channels and outlets for so-called spraying air. These spraying air channels are generally formed by the adhesive channels in an isolated manner in the nozzle.

The substrates or workpieces may, for example (but not definitively) be workpieces from the automotive field or the automotive sector, for example, inner space trim components or the like, which have to be provided, for example, with decorative elements or faces. The hot melt adhesive is particularly suitable for this purpose.

These substrates or workpieces are constructed in a substantially flat or planar manner, for example, in contrast to an injection of adhesives in very deep hollow cavities as known in other fields of the technology. However, these include, for example, 3D carriers from the automotive sector, such as carriers with door trims, boot space trims, consoles, instrument panels and the like. These may absolutely have relief differences of over 100 mm but are in the context of this application substantially planar. Therefore, the adhesive is also applied in strips and the substrate or workpiece is subjected to a relative movement in relation to the device or to the spray nozzles or adhesive outlets.

The device is an application device which, for example, may comprise one or more application heads, wherein a plurality of nozzles are typically associated with an application head. The application head may also comprise a pump station for the adhesive, heating elements and the like. The entire device may, for example, be arranged on a robot arm or even comprise a corresponding robot arm.

The device may also comprise a store of adhesive or be connected to such a store.

The problem addressed is solved according to another related aspect of the invention with the features of claim 2, in particular with those of the characterizing portion, and is accordingly characterized in that the spray nozzle comprises a plurality of parallel plates which as a result of the recesses which are arranged therein form separate channels between a respective adhesive inlet and a respective region of adhesive outlets.

The notion of this aspect therefore substantially involves providing, for two adhesive inlets in a so-called multi-plate nozzle, separate channels which are isolated from each other and which connect the adhesive inlets in each case separately to a region of adhesive outlets.

The notion of the invention which encompasses both aspects thus substantially involves nozzles of a conventional width being modified by an isolation or separation of the channels in such a manner that two separate individually controllable regions of adhesive outlets are produced, which enables controllable adhesive strips with a smaller width.

If there are one or more multi-plate nozzles, these typically comprise at least an inner plate and an outer inlet plate and an outer closure plate. Theoretically, it is also conceivable to provide only two plates. Generally, however, at least three plates, that is to say, the above-mentioned ones, are certainly provided. In practice, a large number of plates are actually provided, that is to say, more than three, as will be explained in greater detail in the following description of the Figures.

In particular, the inner plates are in this instance parallel plates which are supported in a sandwich-like manner between an input and an end plate. Corresponding recesses in the individual plates are then depending on the configuration arranged in a congruent manner with respect to each other. The plates are typically metal plates, for example, high-grade steel plates or the like.

According to the second aspect of the invention, the plates are then configured in such a manner that they form a through-channel from the first adhesive inlet to the first region of adhesive outlets. In a state isolated and separate therefrom, a second channel from the second adhesive inlet to the second region of adhesive outlets is also provided. To this end, in particular the inner plates have at least two adhesive passages which are separated from each other.

Typically, one of the inner plates has the said regions of adhesive outlets. The same plate may, for example, have a plurality of adhesive outlets and in particular at least one spray air outlet may be further associated with each individual adhesive outlet. Alternatively, of course, a common spray air outlet may also be associated with a plurality of adhesive outlets.

Therefore, spray air is also guided and directed in this context in the multi-plate nozzle, in particular from a separate air inlet to the spray air outlets mentioned.

According to a particularly advantageous embodiment of the invention, a region of adhesive outlets may even have a width of less than 20 mm, preferably less than 15 mm, more preferably less than 10 mm, even more preferably less than 5 mm. This enables an even higher resolution when applying the adhesive in the context of an even narrower application strip of the adhesive on the substrate or workpiece.

In the event that the spray nozzle comprises a plurality of parallel plates, in particular an inner guide plate may be provided. This may be used to further direct and/or apply the adhesive. In any case, this inner guide plate is intended to have two separate recesses which are separated from each other to direct the adhesive. Advantageously, these two recesses are constructed in an axially symmetrical manner. In this manner, the entire guide plate may, for example, be constructed in an axially symmetrical manner and be installed in at least two different orientations when the nozzle is assembled.

Advantageously, the so-called guide plate is associated with an outlet plate in such a manner that it can further direct the adhesive to the outlet plate. The guide plate may in this instance be arranged directly beside the outlet plate, or the nozzle may have other additional plates which are located therebetween. The outlet plate may be a plate which, for example, in a lower region, has recesses which may be usable as an outlet for the adhesive.

The recesses of the guide plate for directing the adhesive are in this instance in any case arranged in a partially congruent manner with respect to corresponding recesses of the outlet plate, wherein these recesses of the outlet plate are then also connected to the actual outlets in the outlet plate.

According to a particularly advantageous embodiment of the invention, the device according to the invention comprises a plurality of spray nozzles. This enables a more rapid application of the adhesive. The spray nozzles may in this instance be substantially identical, which facilitates the assembly and the replaceability but also storage thereof.

Typically, the spray nozzles are arranged (and also orientated) transversely relative to the application direction. The application direction is the main extent direction of the application path, that is to say, the direction in which the nozzle is moved relative to the workpiece or substrate.

Advantageously, a plurality of spray nozzles are arranged beside each other on a device. In the most ideal case, the spray nozzles are arranged directly beside each other so that a continuous coverage of a surface portion to which the application is intended to be made is reached with nozzles.

If a plurality of nozzles are provided, these are distinguished in particular in that each of them has a separate housing which is isolated from the others. Isolated in this context is intended to be understood to mean that the channels guided therein do not extend from the outer wall of the housing directly into an adjacent housing, but instead each housing has its own channels (that is to say, not in the sense, for example, of electrically insulated or the like).

As a result of the fact that each nozzle has its own housing, the nozzles may be provided on the device in a modular manner. For example, depending on the application, the number of nozzles can be varied or the like. The nozzles may, for example, be arranged or mounted together on a common application head.

The housing may in particular also be a housing which is formed by the plates already mentioned, that is to say, in particular the outer contours thereof.

According to another advantageous embodiment of the invention, an individual switching valve is associated in each case with the two adhesive inlets of a spray nozzle. The individual outlets are thus each connected to a switching valve. The switching valve may in this instance, for example, be provided by a switching valve module. The switching valve controls in this instance the supply to the adhesive inlet and consequently also to the spray nozzle.

If a region of the spray nozzle is not intended to spray any adhesive, the corresponding switching valve is therefore switched into a blocking state. If the region of the spray nozzle is intended to spray adhesive, however, the switching valve is opened.

In this instance, an individual switching valve is typically associated with each adhesive inlet of the spray nozzle. This is typically not integrated in the spray nozzle, but instead constructed separately from it, preferably as a switching valve module. Such a switching valve module may, however, be arranged in/on the device, in particular on a common application head.

Preferably, there is provision in this instance for the two switching valves to be arranged so as to overlap with respect to the contour of the spray nozzle. This has the advantage that, with a row-like arrangement of a plurality of spray nozzles directly beside each other, two relatively wide switching valve modules can nonetheless be associated with each spray nozzle. Even when a switching valve is wider than half a spray nozzle or a spray nozzle module, as a result of the overlapping construction of the valve modules two switching valves or switching valve modules can be associated with a spray nozzle even in such an arrangement (one for each adhesive inlet of the nozzle). In particular, there is provision in this instance for the switching valves or switching valve modules which are arranged in an overlapping manner in the said arrangement to have a common width which does not exceed the width of the spray nozzle (or the module of the spray nozzle).

With respect to the width, the two switching valves may therefore be “concealed” in the viewing direction behind the spray nozzle.

Alternatively or additionally, there may be provision for the two switching valve modules (which are associated with a common spray nozzle) to be orientated in such a manner that they form an angle of attack. With respect to the longitudinal extent thereof, the switching valve modules which are arranged in two parallel planes may, for example, therefore be arranged in a substantially V-shaped manner with respect to each other. The angle enclosed may, for example, be less than 120°, preferably less than 90°. This enables optimum accessibility, in particular with an overlapping arrangement described above, of the switching valves or switching valve modules.

In case of such a construction of an angle of attack, in particular two rows of switching valve modules may be provided: a first row of switching valve modules is then orientated in a first direction and the second row of switching valve modules in a second orientation, wherein the orientations form the angle of attack between them.

Two sequential (with respect to the direction transverse relative to the application direction) modules may in each case overlap each other as described above.

According to a particularly advantageous embodiment of the invention, a plurality of switching valves of the device are accessible via a common opening mechanism. The opening mechanism may, for example, be a hinge by means of which the application head or a portion of the application head is folded open. This may in particular enable access to one of the above-mentioned rows of switching valves or switching valve modules (which with the other row form the angle of attack between them).

In this manner, an overlapping of switching valves which are sequential or associated together with a single nozzle can be better achieved. Switching valves may in this manner be installed in the device in such a manner that in the closed or assembled state they are in any case at least sometimes not accessible. Only an actuation of the opening mechanism, for example, an opening of the hinge, can enable the accessibility and removability or replaceability thereof.

The hinge may in particular be associated with an adapter which enables the fitting of a plurality of nozzles with two adhesive inlets in each case to an application head which typically for a nozzle provides only one inlet (or outlet from the application head).

However, the opening mechanism may, of course, also be integrated in an adapter-free device.

Finally, according to a particularly advantageous embodiment, there may be provision for a plurality of spray nozzles to be fitted to a common application head. These advantageously each have an individual housing.

In a further advantageous manner, a common pump station may be directly mounted on the application head. This supports a rapid switching of the regions of adhesive outlets, in particular by means of a rapid regulation of the adhesive. The pump station may in particular comprise or form at least one gear pump, which enables a particularly good adjustment of the conveying quantity. As a result of a direct assembly of the pump station on the application head, the use of hoses between the application head and pump station or precision pump(s) may be prevented, which would prevent a rapid adaptation of the required quantity (if fewer regions of adhesive outlets are active, less adhesive is required). A pump station consequently provides a general adhesive reservoir, which can provide adhesive to all nozzles (and consequently also to all switching valve modules) together (and in a controlled manner).

However, the pump station may be connected via a hose, for example, to a bag melter or to another adhesive store.

The application head then naturally provides a distributor function for the adhesive from the pump station to the different nozzle inlets or switching valves.

The device may in particular also be constructed as an adapter or comprise an adapter which enables the fitting of the nozzles with the two adhesive inlets to a conventional application head with actually only one adhesive outlet per nozzle. In this context, the corresponding adapter may contain connection elements for the nozzles, where applicable specially arranged switching valves and/or corresponding retention means and branch channels, which enables the adhesive of an application head outlet onto the two spray nozzle inlets or the two switching valves which are associated therewith.

According to another aspect of the invention, the problem addressed is solved with a method according to claim 12, in particular by the following steps:
supplying adhesive to a spray nozzle through at least two adhesive inlets which can be supplied or switched separately,
separately directing the adhesive in the nozzle to two regions of adhesive outlets,
applying the adhesive to the substrate or workpiece by means of discharge through one of the regions of adhesive outlets with an application width of less than 25 mm, in particular less than 20 mm, furthermore in particular less than 15 mm, furthermore in particular less than 10 mm.

All of the advantages and features mentioned in connection with the device described are also intended to be considered to be disclosed in connection with the method according to the invention and vice versa.

Other advantages will be appreciated from the following description of the Figures and the corresponding Figures. In the drawings:

FIG. 1: shows the result of a method already described from the prior art for applying adhesive strips to a motor vehicle carrier component,

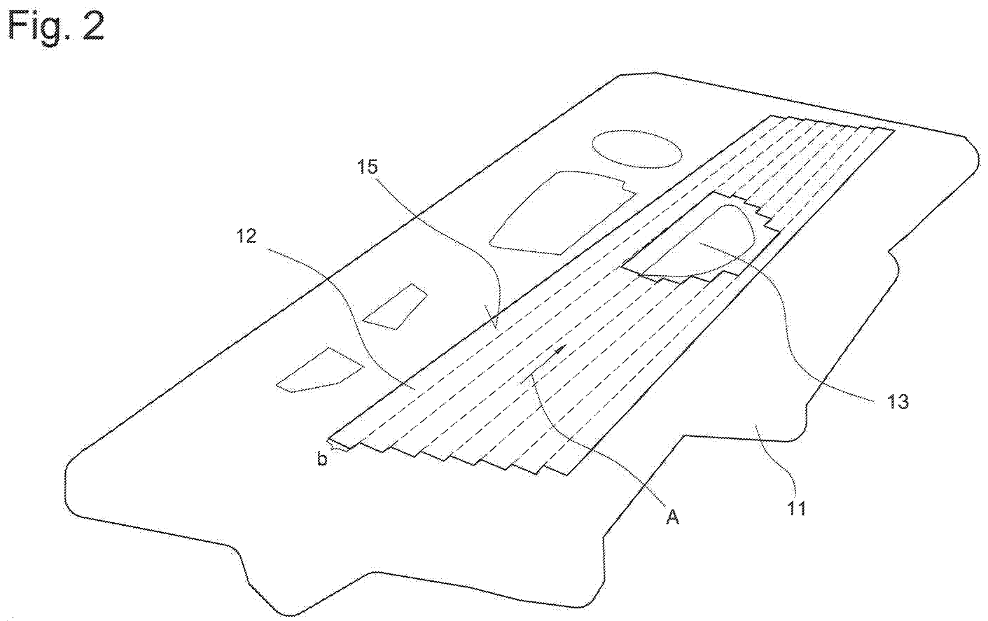

FIG. 2: shows in a view approximately in accordance with FIG. 1 the result of a method according to the invention using a device according to the invention with a higher number of adhesive strips, each with a smaller width in a linear orientation,

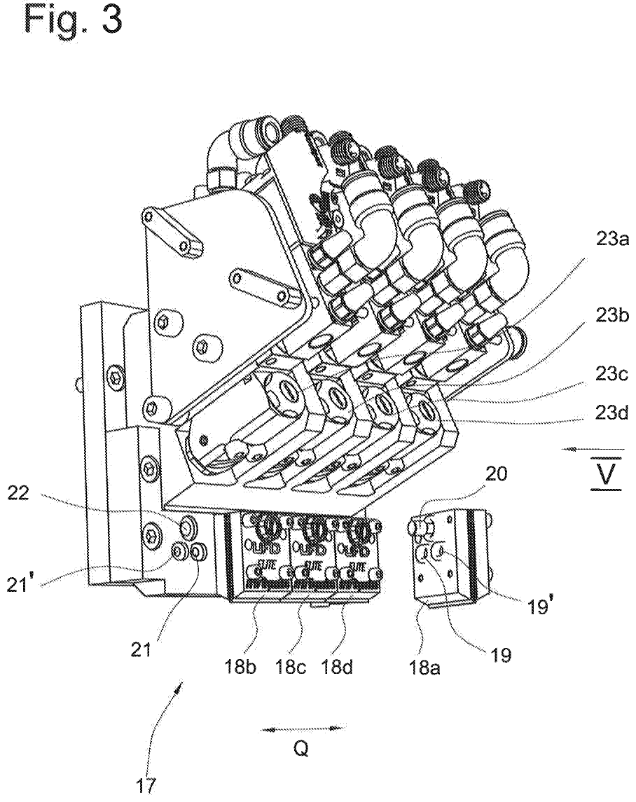

FIG. 3: is a highly schematic, isometric outer view of a portion of a device according to the invention, in particular in the form of an adapter, wherein one of the nozzles, for the sake of clarity, is illustrated in the disassembled state,

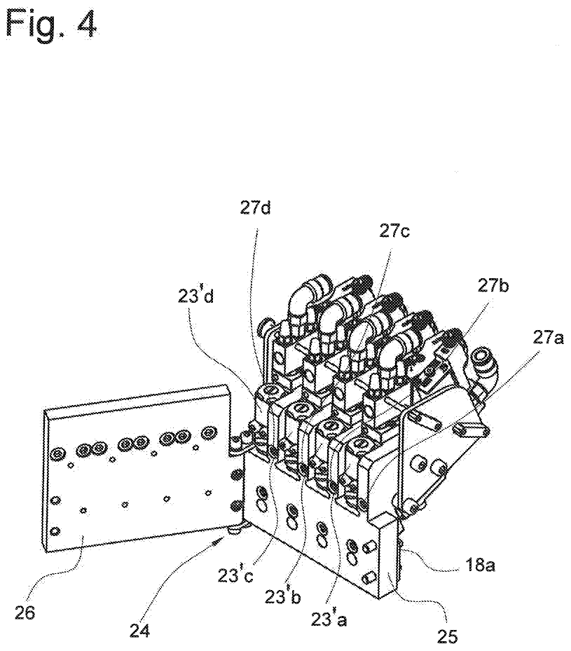

FIG. 4: shows the portion of the device according to FIG. 3 in a view opened via a hinge,

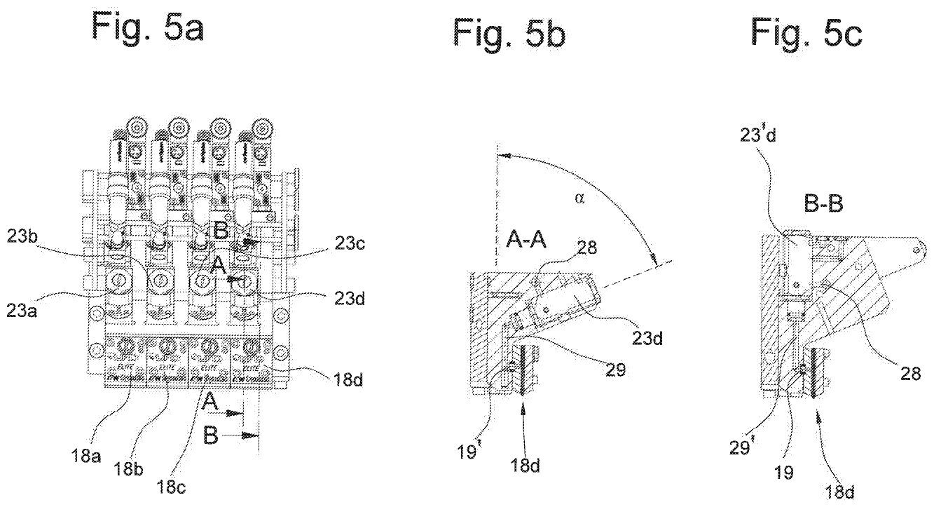

FIG. 5a: is a front view of the portion of the device according to FIG. 3, approximately in accordance with the view arrow V in FIG. 3, with the nozzles fully assembled,

FIG. 5b: is a section through FIG. 5a along the line of section A-A,

FIG. 5c: is a section through FIG. 5a along the line of section B-B in FIG. 5a,

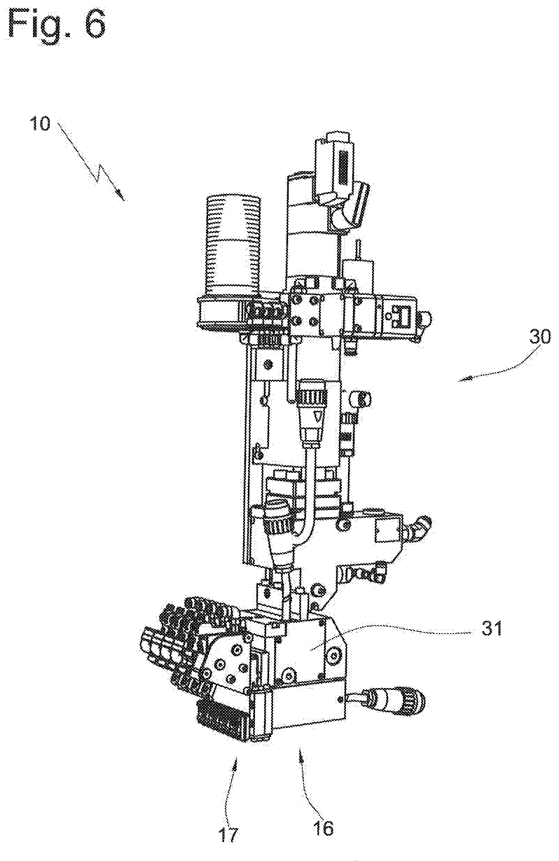

FIG. 6: is an isometric, highly schematic view of an application head with the pump station assembled,

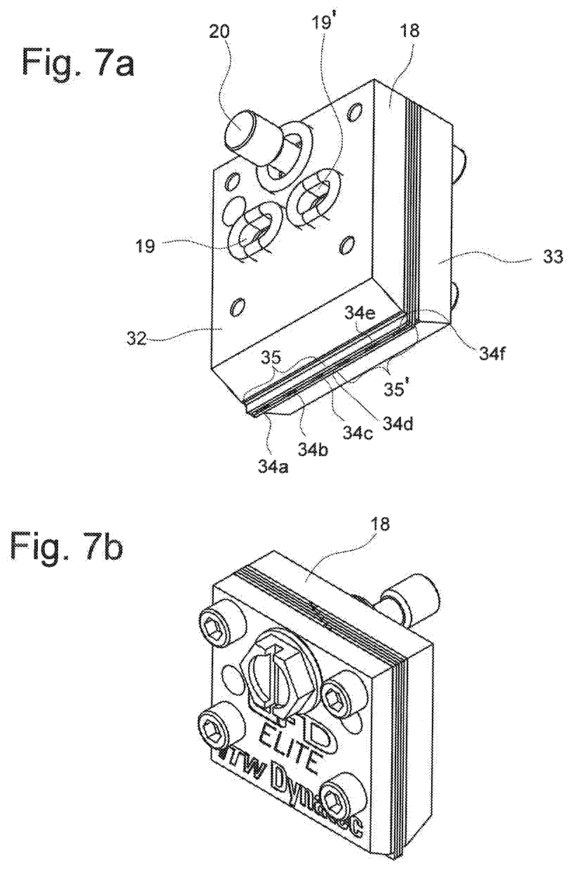

FIG. 7a: is a rear, detailed view of a disassembled spray nozzle,

FIG. 7b: is a front view of the spray nozzle according to FIG. 7b and

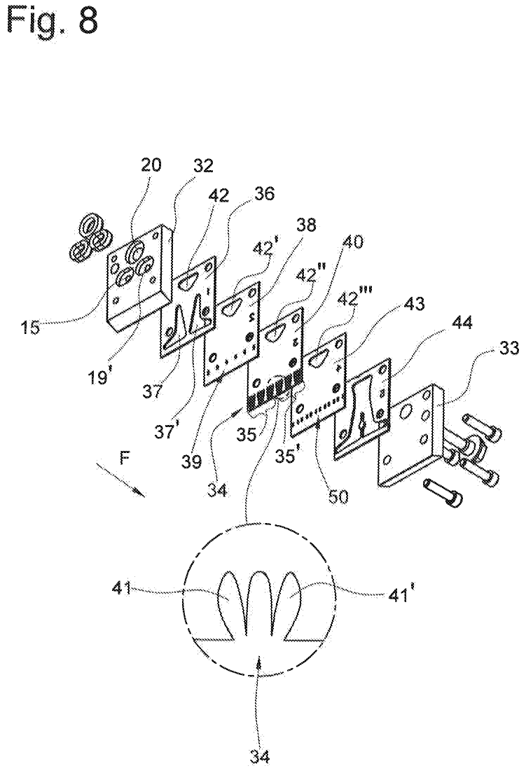

FIG. 8: is an exploded view of the spray nozzle illustrated in FIG. 7 with a plurality of parallel plates.

Prior to the following description of the Figures, it should be noted that identical or comparable components are sometimes provided with identical reference numerals, where applicable with the addition of lower case letters or apostrophes. The patent claims which follow the description of the Figures therefore sometimes have only the corresponding reference numerals without additions.

In the Figures, FIG. 2 initially shows the result of a method according to the invention for spraying adhesive using a device 10 according to the invention which is described in even greater detail in the following Figures.

FIG. 2 shows the same workpiece 11 as FIG. 1, that is to say, for example, a carrier component from the automotive sector in the manner of a door trim, in particular with a recess 13. FIG. 2 shows that the applied adhesive strips 12 have a smaller width b than the width b′ according to the prior art in accordance with FIG. 1.

The width b of the adhesive strip according to FIG. 2 may, for example, be less than 25 mm, in particular less than 20 mm, furthermore in particular less than 15 mm, for instance, approximately 12.5 mm.

As a result of the smaller width b, per width portion of the workpiece 11 there are naturally more adhesive strips 12 applied. The adhesive strips 12 have in addition the advantage that they are all orientated in a linear manner in the application direction A.

In contrast to FIG. 1, therefore, the spray nozzles according to FIG. 2 do not need to be guided along a curved path, but instead only along a straight line. As a result of the smaller width b and consequently a better “resolution” of the application, it is possible, for example, for the recess 13 to be taken into account and moved closer to the edges without curved paths being required. The application pattern is sufficiently good and extends sufficiently close to the recess 13.

In addition, the edges of the workpiece 11 may be included in such a manner that it is possible to work substantially parallel with the edges thereof so that occurrences of overlapping of the adhesive paths 12 can substantially be avoided.

Also as a result of the avoidance of curved paths, a more rapid cycle time can be achieved. In the embodiment according to FIG. 2, it is, for example, possible to use an application head which has four nozzles or nozzle modules. Each of these spray nozzle modules—as will be set out further below—can be associated with two adhesive inlets and accordingly also two regions of adhesive outlets. This consequently leads to the eight illustrated adhesive paths 12 using an application head with four spray nozzles which each have two regions of adhesive outlets which can respond independently of each other.

In the embodiment, the adhesive strips 12 comprise the applied adhesive 15, which may, for example, be a hot melt adhesive.

In order to produce the application pattern according to FIG. 2, it is possible, for example, to use an application head 16, as illustrated, for example, in FIG. 6. This application head 16 has according to FIG. 6 in particular a front portion 17 which is illustrated to an enlarged scale in FIG. 3.

FIG. 3 illustrates in this instance that the front portion 17 comprises four spray nozzles 18a to 18d which are mounted beside each other (in FIG. 3, the first spray nozzle 18a is illustrated in a non-assembled state only for reasons of clarity).

The spray nozzles 18 are orientated in an identical manner and arranged or mounted directly beside each other in a transverse direction Q, transversely relative to the application direction A. Each of the nozzles 18 has two separate adhesive inlets 19 or 19′. Furthermore, an inlet 20 for spray air is provided on each nozzle 18. The inlets 19, 19′ and 20 (which in FIG. 3 can be seen naturally only for the spray nozzle 18a) are supplied via corresponding inlets 21 or 21′ (for the adhesive) and 22 (for the spray air) on the front portion 17 of the application head 16.

Each of the nozzles 18 is connected via one of the inlets 19 or 19′ thereof or via a channel system which is not yet illustrated in FIG. 3 to one of the switching valves 23a to 23d illustrated in FIG. 3. The switching valves 23 are in the context of this application also referred to as switching modules.

In addition to the four switching valves 23a to 23d, however, the front portion 17 has four additional switching valves 23′a to 23′d. These are arranged in a concealed manner and can be seen, for example, in Figure 4, which shows, for example, a rear view of the front portion 17 illustrated in FIG. 3.

The front portion 17 is according to FIG. 4 illustrated in an open position in which the switching valves 23′ can be accessed better or even at all, for example, for maintenance or replacement operations.

To this end, the front portion 17 provides a hinge 24 which provides an opening mechanism for the front portion 17. The front portion 17 may comprise in this context, for example, a securing portion 25 and an assembly portion 26 which are connected to each other via the hinge 24 and which are constructed so as to be able to be pivoted relative to each other.

FIG. 4 illustrates not only that the front portion 17 is a front portion which can be opened. Instead, FIG. 4 additionally illustrates that the front portion 17 is constructed on the whole as an application adapter. Accordingly, the application head 16 or the entire device 10 thus comprises an application adapter 17.

In this context, the application adapter 17 is an adapter because it enables the use of the illustrated nozzles 18 with two adhesive inlets 19, 19′ in a conventional base portion of the application head 16 with in principle only a single adhesive supply per nozzle. FIG. 4 thus illustrates that per nozzle 18 only one adhesive supply 27a to 27d is provided. This supply is divided or split in the manner of a switch in the adapter 17, in particular in the securing portion 25, so that two outlets 21, 21′ can be supplied via the supply 27a to 27d per nozzle 18a to 18d.

Each supply 27 or each nozzle 18 is in this instance associated with an offset pair of the switching valves 23 or 23′. In this context, there is arranged upstream of the two adhesive inlets 19 or 19′ precisely one switching valve 23 or 23′ which controls or switches the supply of this inlet 19 or 19′ with adhesive. In the illustrated embodiment, the switching valve 23′a is arranged, for example, upstream of the adhesive inlet 19 of the spray nozzle 18a and the switching valve 23a is arranged upstream of the adhesive inlet 19′ of the nozzle 18a.

This offset arrangement of the two rows of switching valves 23a to 23d and 23′a to 23′d enables in this instance a particularly space-saving arrangement which in any case to some extent FIG. 5 also illustrates:

Thus, FIG. 5a is a front view of the front portion 17 of the application head 16 or the device 10 in which only the first row of switching valves 23a to 23d can be seen. The sections through FIG. 5a A-A (cf. FIG. 5b) and B-B (cf. FIG. 5c) illustrate, however, the tilted and consequently space-saving arrangement of the two switching valve rows with respect to each other by way of example, with reference to the switching valves 23d and 23′d. In this context, the two switching valve rows enclose an angle of attack α. In this instance, FIG. 5 also shows that the two switching valves 23 or 23′ of a switching valve pair which is associated with a nozzle 18 overlap in the viewing direction approximately in accordance with FIG. 5a. In FIG. 5a, as already noted, the switching valve 23′d cannot be seen. However, the axes of section A-A and B-B then illustrate the overlapping since they relate substantially to the center axes of the switching valves (modules) 23d to 23′d.

FIGS. 5b and 5c further illustrate in overview that both switching valves 23 or 23′ which are associated with a common nozzle 18 are supplied by a common channel 28 which itself in turn is supplied with adhesive by one of the supplies 27 according to FIG. 4.

However, the two switching valves 23d and 23′d then have separate supply channels 29 and 29′ which are isolated from each other to the corresponding spray nozzle 18. At least two switching valves 23 or 23′ are thus always associated with a nozzle 18.

FIG. 6 illustrates that the front portion 17 receives the adhesive (in particular via the mentioned supplies 27) from a pump station 30 which is securely mounted on the application head 16, in particular without adhesive-guiding hoses being interposed.

In addition to adhesive, however, spray air can naturally also be supplied to the application head 16 via the pump station 30. For example, the pump station 30 may also contain a corresponding valve arrangement for the spray air and/or naturally pumping means, such as gear pumps, for the adhesive.

As a result of the fact that no hoses are used between the application head and pump station or precision pump, but instead the pump station 30 is mounted directly on the application head 16, there can be achieved much more rapid quantity regulation times of the adhesive which, for an application pattern, as illustrated in FIG. 2, are absolutely necessary: the two regions (which are yet to be described) of adhesive outlets of a single spray nozzle 18—as described—have to be able to be switched independently of each other. In principle, although the switching valves 23 or 23′ are provided therefor, the total quantity of adhesive must be able to be varied for the different switching states. For example, in total less adhesive should be discharged from a nozzle 18 if only one of the regions of adhesive outlets thereof is active. If the pump station 30 did not exist or it could not be regulated, no strips 12 with a homogeneous application quantity would be possible.

So that an optimum supply is achieved, the pump station is integrated directly in the device, in particular mounted on the application head 16. The supply component 31 of the application head 16 may then ensure direction of the adhesive and the spray air onto the front portion 17 or the module 17.

FIG. 7 then shows two large isometric illustrations of a spay nozzle 18 of the device 10 according to the invention, wherein the rear view according to FIG. 7a once again illustrates the two adhesive inlets 19 or 19′ and the spray air inlet 20. Furthermore, however, a plate-like construction of the plate-like spray nozzle 18 can also already be seen. Between an inlet plate 32 and an end or termination plate 33 it is thus possible to see a plurality of parallel narrow plates which, in particular at the lower side of the nozzle 18, form a plurality of adhesive outlets 34a to 34f.

These adhesive outlets 34 are in this instance associated in groups with the two adhesive inlets 19 or 19′ so that the nozzle 18 shown according to FIG. 7 forms a total of two regions 35 and 35′ of adhesive outlets 34.

The connection between the individual adhesive outlets 34 and the two adhesive inlets 19 or 19′ of a nozzle 18 is then shown in the exploded illustration according to FIG. 8: there is first provided an inlet plate 32 with the adhesive inlets 19 or 19′ which are associated therewith and which are formed therein (the attachments of the inlets 19 or 19′ may, as illustrated, be separate components or constructed integrally with the plate 32).

In the flow direction F there is arranged directly downstream of the inlet plate 32 a guide plate 36 which in particular has two axially symmetrical recesses 37 or 37′ for directing the adhesive. The recesses 37 or 37′ are in the embodiment in particular constructed in a kidney-like manner.

In the flow direction F there then follows a second guide plate 38 which has a plurality of smaller recesses for associating the adhesive on the adhesive outlets 34. Finally, in the flow direction F there follows an outlet plate 40 having a plurality of edge recesses which in the embodiment illustrated constitute the adhesive outlets 34a to 34f. Each adhesive outlet 34 is surrounded in a flanking manner by two spray air outlets 41 or 41′ which, as will be described below, are supplied with spray air and which are intended to carry the discharged adhesive in a desired path onto the workpiece 11 or the substrate.

FIG. 8 consequently illustrates as an interim conclusion that the three left adhesive outlets 34 which are associated with the outlet plate 40 are associated with the recess 37 of the plate 36 and consequently the adhesive inlet 19 of the nozzle 18. The three adhesive outlets 34 in the outlet plate 40 which are arranged on the right are in contrast associated with the recess 37′ in the guide plate 36 and consequently with the other adhesive inlet 19′ of the nozzle 18.

Finally, the guiding of the spray air in the nozzle 18 is further intended to be explained with reference to FIG. 8: the spray air thus passes through the inlet 20 of the inlet plate 32 into the nozzle and is first directed through congruent passages 42, 42′, 42″ and 42′″ in the plates 36, 38, 40 and 43 as far as an air direction plate 44. In the air direction plate there is a redirection of the spray air, downward with respect to FIG. 8, and then back through the lower recesses 50 of the plate 43 into the spray air recesses 41 to 41′ of the outlet plate 40.

For example, there may be provision in this instance for both regions 35 and 35′ to be constantly supplied with spray air by adhesive outlets, although only one of the two regions 35, 35′ actually discharges adhesive 15. However, there may in principle also be provided a separate switching of the two regions 35, 35′ with respect to the spray air.

It should finally be noted that in the Figures both the width of the application strip and the width of a region of outlets purely for reasons of simplicity is provided with the reference numeral “d” (the region width thus corresponds in the example substantially to the strip width).

1. A device for spraying adhesive onto a substrate or workpiece, for example, an automotive workpiece, comprising at least one spray nozzle for discharging the adhesive having at least two adhesive inlets and at least two regions of adhesive outlets, wherein one of the regions of adhesive outlets which can be supplied or switched separately with a width (b) of less than 25 mm is connected to precisely one of the adhesive inlets.

2. The device as claimed in claim 1, wherein the spray nozzle comprises a plurality of parallel plates which as a result of recesses which are arranged therein form separate channels between a respective adhesive inlet and a respective region of adhesive outlets.

3. The device as claimed in claim 1, wherein one of the regions of adhesive outlets which can be supplied or switched separately and which has a width (b) of less than 25 mm, and which is connected to precisely one of the adhesive inlets has a width (b) of less than 20 mm, preferably less than 15 mm, more preferably less than 10 mm.

4. The device as claimed in claim 1, wherein the plurality of parallel plates which comprises the spray nozzle and which, as a result of recesses arranged therein form separate channels between an adhesive inlet and a region of adhesive outlets in each case, have an inner guide plate which has two separate, in particular axially symmetrical, recesses through which adhesive can flow.

5. The device as claimed in claim 4, wherein the guide plate is directly or indirectly associated with an outlet plate, having outlets for the adhesive.

6. The device as claimed in claim 1, wherein the device comprises a plurality of in particular identical spray nozzles which are preferably arranged transversely relative to the application direction (A), in particular directly, beside each other, more preferably orientated in the same direction.

7. The device as claimed in claim 6, wherein each of the nozzles has an individual separate housing which is in particular isolated from the others.

8. The device as claimed in claim 1, wherein there is associated in each case, in particular clearly, with the two adhesive inlets of a spray nozzle an individual switching valve which is preferably constructed separately from the spray nozzle, wherein there is preferably provision for the two switching valves, which are each associated with one of the two adhesive inlets of a spray nozzle, to be arranged in an overlapping manner with respect to the contour of the spray nozzle.

9. The device as claimed in claim 8, wherein two switching valves or the switching valve modules thereof, which are each associated with one of the two adhesive inlets of a spray nozzle are orientated in such a manner, in particular in parallel planes, that they form an angle of attack (α), wherein there is preferably provision for all the switching valves or the switching valve modules thereof of the device to be arranged in one of these two orientations.

10. The device as claimed in claim 1, wherein a plurality of switching valves of the device are accessible via a common opening mechanism, in particular in the form of a hinge.

11. The device as claimed in claim 1, wherein a plurality of spray nozzles are fitted to a common application head of the device, on which a common pump station for the adhesive, is mounted, in particular without hoses.

12. A method for spraying adhesive onto a substrate or workpiece, for example, an automotive workpiece, comprising the steps of:
supplying adhesive to a spray nozzle through at least two adhesive inlets which can be supplied or switched separately;
separately directing the adhesive in the nozzle to two regions of adhesive outlets; and
applying the adhesive to the substrate or workpiece by means of discharge through one of the regions of adhesive outlets with an application width (b) of less than 25 mm, in particular less than 20 mm, furthermore in particular less than 15 mm, furthermore in particular less than 10 mm.
